(19) United States
(12) Patent Application Publication
(10) Pub. No.: US 2018/0121629 A1
(43) Pub. Date: May 3, 2018

(54) DEVICE FOR TREATMENT COMPLIANCE AND EVENT TRACKING

(71) Applicant: PORTAL INSTRUMENTS, INC., Cambridge, MA (US)

(72) Inventors: Robert J. Dyer, Cambridge, MA (US); Patrick Anquetil, Cambridge, MA (US); Danielle Class, Cambridge, MA (US); Mark Philip, Cambridge, MA (US)

(21) Appl. No.: 15/796,164

(22) Filed: Oct. 27, 2017

Related U.S. Application Data
(60) Provisional application No. 62/414,356, filed on Oct. 28, 2016.

(51) Int. Cl. G06F 19/00

(52) U.S. Cl. CPC G06F 19/3456; G06Q 50/24; G06F 19/3475

(57) ABSTRACT

A compliance tracking device includes a receiver configured to receive a signal from at least one sensor, the signal containing information regarding at least one container of medicine; a processor configured to determine, from the information, a communication regarding the at least one container of medicine; a network interface configured to transmit the communication; and a user interface configured to provide an indication regarding the at least one container of medicine.

### CROSS REFERENCE TO RELATED APPLICATIONS

This application claims priority under 35 U.S.C. § 119(e) to U.S. Provisional Application Ser. No. 62/414,356, titled “DEVICE FOR TREATMENT COMPLIANCE AND EVENT TRACKING,” filed Oct. 28, 2016, which is incorporated herein by reference in its entirety.

### BACKGROUND

### Technical Field

The application relates generally to tracking the administration of medicine, and more particularly, in one aspect, to systems and methods for improving compliance with prescribed treatment regimens.

### Background

The failure of patients to satisfactorily comply with treatment regimens for a particular disorder may lead to less optimal outcomes in treating the disorder, which in turn leads to increased costs to the patient, medical care provider, and payer (e.g., insurance company). Non-compliance leads to additional care requirements in the future, as well as the waste of expensive medications not being administered. On the other hand, higher levels of compliance may generally lead to better outcomes for disorders requiring such treatments. Better outcomes will typically reduce average costs for the patient, medical care provider, and payer.

To the extent compliance or non-compliance is not apparent from a medical outcome, it must currently be self-reported by the patient. Yet patients may be inaccurate reporters due to memory issues, mistake, or bias. Even when patients provide accurate compliance information to medical professionals, the infrequency of visits between patients and care providers may allow long periods of non-compliance to occur before an issue is discovered.

### SUMMARY

According to one aspect, a compliance tracking device includes a receiver configured to receive a signal from at least one sensor, the signal containing information regarding at least one container of medicine; a processor configured to determine, from the information, a communication regarding the at least one container of medicine; a network interface configured to transmit the communication; and a user interface configured to provide an indication regarding the at least one container of medicine.

According to one embodiment, the information includes at least one of a proximity of the at least one container to the receiver, a quantity of the medicine, an expiration status of the medicine, a temperature of the medicine, an ambient temperature at the container, and an indication that the container has moved. According to a further embodiment, the information includes an indication that the at least one container has been removed from a first location. According to a still further embodiment, the sensor is at least one of a weight sensor, an optical sensor, an acoustic sensor, an inductance sensor, a capacitance sensor, a conductive contact sensor, a temperature sensor, an RFID tag, and a smart chip.

According to another embodiment, the compliance tracking device further includes a motion sensing component configured to detect a movement in a proximity of the compliance tracking device. According to still another embodiment, the compliance tracking device further includes at least one of an audio or visual alarm component configured to be activated in response to a determination regarding the at least one container of medicine. According to yet another embodiment, the network interface is configured to transmit the communication to a server. According to a further embodiment, the network interface is configured to transmit information regarding at least one treatment event to at least one of a medical professional, a public safety dispatcher, a caretaker, an emergency contact, and a family member.

According to one embodiment, the network interface is configured to communicate with a medical treatment device configured to administer the medicine in a treatment of the patient. According to a further embodiment, the network interface is configured to receive, from the medical treatment device, information regarding at least one treatment event. According to a further embodiment, the network interface is configured to communicate with the medical treatment device over at least one of a IEEE 802.11 network, a Bluetooth connection, and a Bluetooth Low Energy connection. According to a still further embodiment, the user interface is further configured to provide an indication regarding at least one of an upcoming treatment event, a quantity of the medicine, an expiration status of the medicine, and a temperature of the medicine. According to yet a further embodiment, the indication is at least one of a visual notification and an audible notification.

According to a further embodiment, the user interface is further configured to provide an indication regarding a status of the medical treatment device. According to a still further embodiment, the status relates to at least one of a power source of the medical treatment device and an operational status of the medical treatment device. According to yet a further embodiment, the user interface is further configured to receive, from a user, an instruction to the medical treatment device to issue an alert, and wherein the network interface is further configured to transmit the instruction to the medical treatment device.

According to one embodiment, the receiver further includes a receiver antenna, with at least a portion of the receiver antenna configured to be positioned to receive the signal from the at least one sensor. According to another embodiment, the compliance tracking device further includes a component configured to detect a favorable condition for receiving the signal from the at least one sensor. According to a further embodiment, the component is at least one of an accelerometer and a light sensor.

According to one embodiment, the receiver is further configured to detect a distance between the receiver and a fixed sensor and identify, based on the distance, a favorable condition for receiving the signal from the at least one sensor. According to another embodiment, the user interface is further configured to display a first indication regarding an upcoming treatment event; detect a user interaction with an element of the user interface; and cease displaying the first indication responsive to detecting the user interaction. According to a further embodiment, the user interaction with the element of the user interface is a user pushing a user interface button indicating at least one of the user's compliance with the upcoming treatment event and the user's request to cancel the first indication. According to a further embodiment, the user interface is further configured to display, following a predetermined time period after the user interaction, a second indication regarding the upcoming treatment event. According to a still further embodiment, the user interaction with the element of the user interface is a user pushing a snooze button.

According to one embodiment, the network interface is further configured to transmit an order for a refill of medicine. According to another embodiment, the network interface is further configured to request an interactive communication with at least one of a medical professional, a public safety dispatcher, a caretaker, an emergency contact, and a family member. According to still another embodiment, the user interface is further configured to allow a user to transmit at least one of an image, an audio communication, and a video communication to at least one of a medical professional, a public safety dispatcher, a caretaker, an emergency contact, and a family member.

According to yet another embodiment, the user interface is further configured to receive, via an audio sensor, at least one voice command from a user; determine a responsive communication to be provided to the user in response to the at least one voice command; and communicate the responsive communication via the user interface. According to another embodiment, the processor is further configured to determine an effectiveness of an intervention.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A is a block diagram of a connected health platform including a tracking device according to one or more embodiments;

FIG. 1B is a block diagram of components of the connected health platform of FIG. 1A according to one or more embodiments;

FIG. 2 is a block diagram of the tracking device of FIG. 1A according to one or more embodiments;

FIG. 3 is a block diagram of the connected health platform of FIG. 1A, further including a mobile device, according to one or more embodiments;

FIG. 4A is a flow chart of a method for using the tracking device according to one or more embodiments;

FIG. 4B is an exemplary user interface during one or more steps of the flow chart in FIG. 4A;

FIG. 5A is a flow chart of another method for using the tracking device according to one or more embodiments; and

FIG. 5B is an exemplary user interface during one or more steps of the flow chart in FIG. 5A.

### DESCRIPTION

According to one or more embodiments, methods and systems are provided for improving compliance with a drug treatment regimen using a treatment compliance tracking device. The tracking device is configured to communicate with a patient via a user interface regarding compliance with a treatment regimen of medicine the patient has been prescribed. The tracking device may also detect events and conditions related to compliance, or may receive information about such events and conditions from other components of a compliance tracking system, such as a needle-free injector.

If the patient has not complied with the treatment regimen, the tracking device may take escalating actions to intervene, or may request that others (e.g., a caregiver) intervene to address the compliance issues. For example, the tracking device may issue visual and/or audible alarms to the patient if a treatment event is missed; if subsequent treatment events are missed, the tracking device may take additional configurable actions, such as calling or messaging a caregiver, an emergency dispatcher, or a medical professional (e.g., the patient's physician).

Compliance information may be reported to a central server for analysis and/or to be relayed to a medical professional, pharmacy, medical insurance company, or the like. The effectiveness of interventions by the tracking device may also be tracked by the tracking device and/or a server. For example, a patient's compliance with a treatment regimen, either for a specific treatment event or over a number of treatment events spanning a period of time, may be compared to any interventions required during that time period. The effectiveness of the intervention in improving compliance may therefore be estimated or measured.

The tracking device may incorporate one or more sensors configured to detect events or conditions relating to the medicine(s) involved in the treatment regimen. For that reason, the tracking device may be positioned near a storage location of such medicines. For example, the tracking device may be configured to be mounted on a refrigerator in which the medicine is kept. Each container of medicine therein may incorporate a tag (e.g., an RFID chip) that identifies the medicine, the patient, the medicine's expiration date, or other information relating to the medicine or the patient. The sensor of the tracking device may detect when a container of medicine is removed from the storage location, and may use this information to anticipate an impending treatment event, determine an amount of medicine remaining in the storage location, and/or order a refill of medicine (e.g., from a pharmacy). If, on the other hand, the sensor of the tracking device does not detect movement of a container of medicine for some amount of time, the tracking device may be configured to intervene by alerting the patient and/or others about the non-compliance with the treatment regimen.

The tracking device may incorporate or rely on other sensors configured to detect one or more events or conditions relating to the medicine, the patient, or the patient's compliance with the treatment regimen. For example, the tracking device may incorporated a motion or proximity sensor to detect when someone (e.g., the patient) is near the tracking device, and in response may provide a reminder or other notification to the patient regarding a current or upcoming treatment. As another example, the tracking device may incorporate or communicate with a thermometer configured to detect a temperature of the medicine (e.g., with a resistor located on the container) or an ambient temperature inside the storage location (e.g., the refrigerator) or outside the storage location.

In some embodiments, additional components may be positioned near the stored medicine, and may communicate with the tracking device regarding events involving the stored medicine. For example, the medicine may be stored on a scale or other weight sensing-component in the storage location, with the weight being indicative of an amount of remaining medicine. An optical sensor may also be used to detect the removal or addition of containers of medicine. A tray with multiple storage compartments may be provided, with each storage component having a sensor to detect whether a container of medicine is present in the compartment.

The tracking device may also be configured to communicate with a medical device, either directly or via a server with which both devices are in communication. The medical device may be a needle-free injector, and may be configured to communicate information to the tracking device regarding one or more treatment events, including the time of the treatment event, an indication of the success of the treatment event, information regarding the performance of the medical device during the treatment event (including any malfunctions or event parameters, such as an actuator speed of a needle-free injector), or the like. The tracking device may also be configured to communicate information or requests to the medical device. For example, in response to a request by the patient who has misplaced the medical device, the tracking device may transmit to the medical device a request to issue an audible alert so that the medical device can be located by the patient.

The user interface of the tracking device may provide a visual display, such as a display screen, as well other visual indicators, such as a flashing light indicator to signal the patient. The tracking device may convey information to the patient via the visual display, including information about a treatment event that is upcoming, due, or past due; an indication of an amount of medicine left in the storage location; an indication of the temperature of a container of medicine; a reminder or invitation to refill a prescription for the medicine; or other information relating to the treatment event, such as a reminder, given within a certain time before or after a treatment event, not to eat or drink, or a reminder to take the medicine out of the refrigerator so that it begins to warm. The light indicator may signal the patient has a treatment event due by flashing intermittently. If the treatment event is missed such that it becomes overdue, the light indicator may flash at a faster speed to convey urgency. The user interface may also include an audio output device for communicating information, reminders, and alerts to the patient and others.

The user interface may also be configured to receive input from the patient or other users. For example, after prompting the patient to administer a treatment, the user interface may provide the option for the patient to indicate that the treatment was successfully administered or, alternately, that the patient intends to skip that treatment event, and that no further reminders are desired. The user interface may also allow the patient to initiate communication with a family member, medical professional, pharmacist, or the like, such as by audio/video means, or allowing for textual selection or input (e.g., pushing a button that transmits the message “Please call me” to the patient's doctor).

The tracking device and/or the medical device may be configured to communicate with one or more servers in the system via protocols including 3G, 4G, Bluetooth, or Wifi. The servers may be part of a cloud computing network. The server may also be in communication with computer systems associated with the patient's medical professional (e.g., doctor), pharmacy, health insurance company, or other third party, and may be configured to communicate with a guardian or family member of the patient.

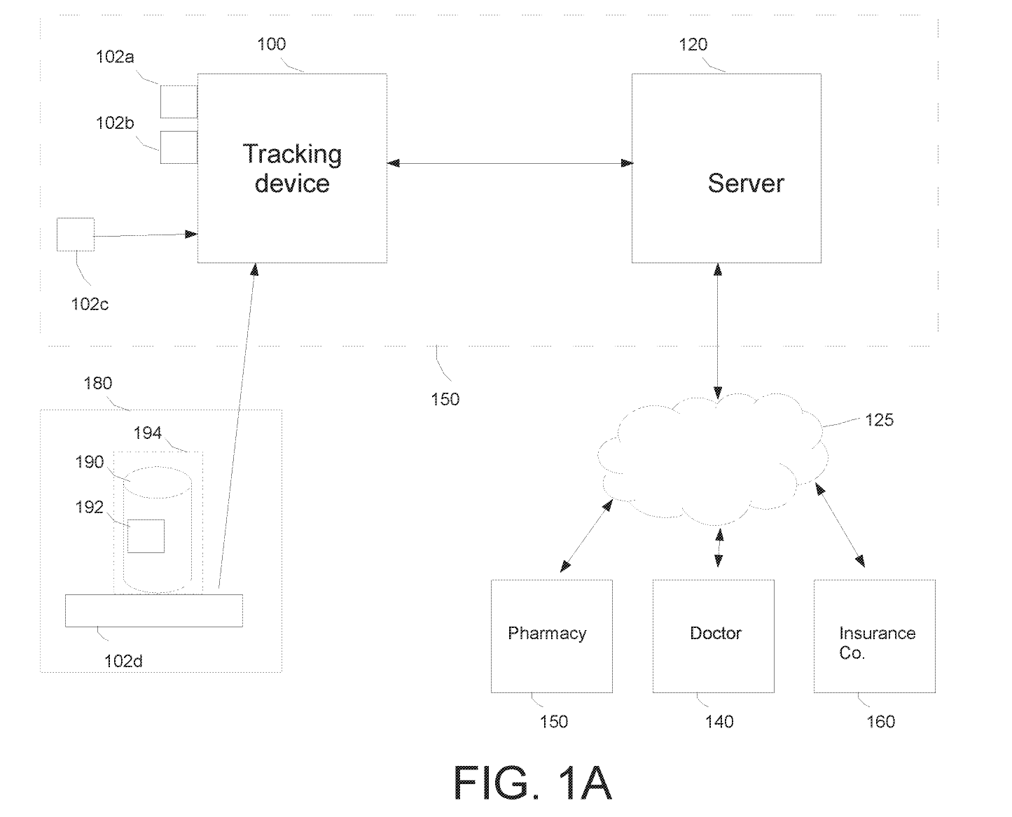

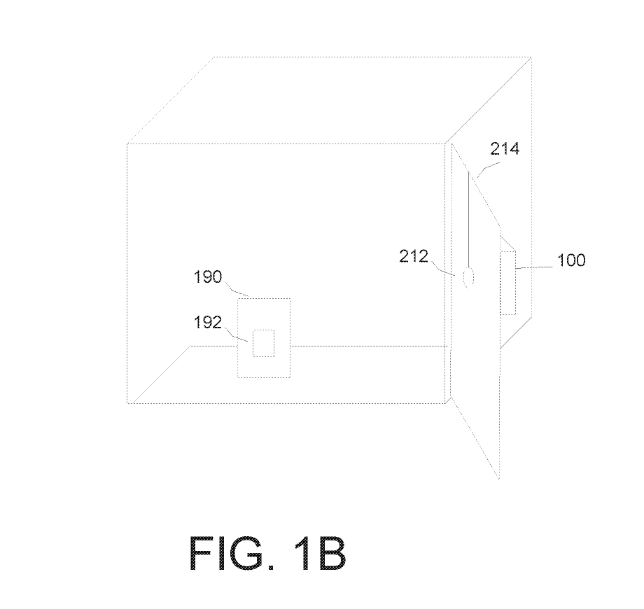

FIG. 1A illustrates a block diagram of a compliance tracking system 150 including a tracking device 100 according to one or more embodiments. In the embodiment shown in FIG. 1A, the tracking device 100 is configured to receive data from a plurality of sensors 102a-d incorporated with, or in a proximity to, the tracking device 100, the data indicating or relating to patient compliance with a treatment regimen that includes medicine stored in a container 190. In some examples, the container 190 incorporates a tag 192 (e.g., an RFID tag) to facilitate tracking compliance. In other examples, the tag may be incorporated into packaging 194 of the container 190, such as a box, carton, wrapper, or label.

The tracking device 100 is further configured to communicate with a server 120 regarding patient compliance. The server 120 may then communicate with the patient's medical professional 140, pharmacist 150, or medical insurance company 160, e.g., through a cloud-based network 125. In some embodiments, the tracking device 100 and/or the server 120 are further configured to communicate with a medical device 130, such as a needle-free injector.

Components of the tracking device 100 may be disposed inside a housing (not shown), and the tracking device 100 may be configured to be mounted or otherwise positioned on or adjacent a storage location 180 of the container 190. For example, the tracking device 100 may incorporate a mounting plate to allow the tracking device 100 to be affixed to a surface of the storage location 180, or a nearby location. In one embodiment, the tracking device 100 may incorporate a magnet so that the tracking device can be positioned on a metallic surface of the storage location 180, e.g., a refrigerator door.

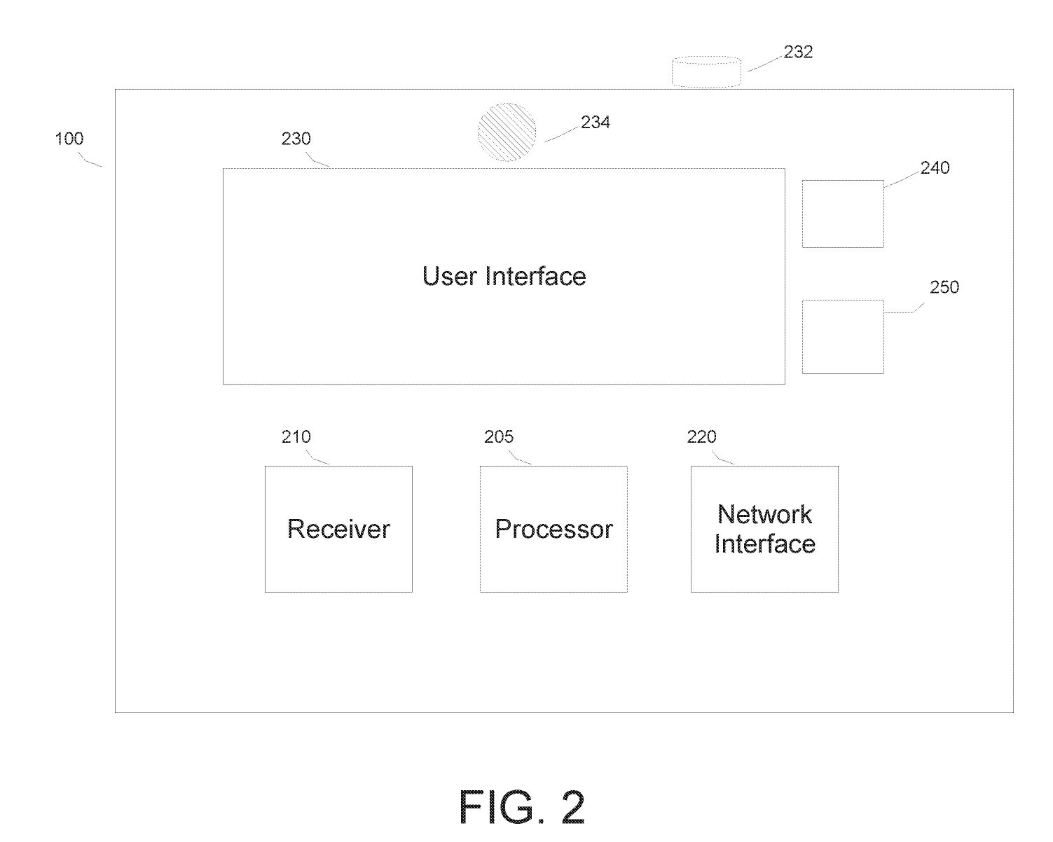

A block diagram of the tracking device 100 is shown in FIG. 2. With reference to FIGS. 1A and 2, the tracking device 100 incorporates a processor 205, a receiver 210, a network interface 220, a user interface 230, a visual indicator 232, an audio indicator 234, and a plurality of user interface input elements 240, 250.

The receiver 210 of the tracking device 100 is configured to receive signals from the plurality of sensors 102a-d. The signal contains, or is indicative of, information regarding the container 190. While the examples here show a single container 190 for ease of illustration, it should be appreciated that the plurality of sensors 102a-d may receive information from one or more of a plurality of containers 190. The information regarding the container 190 may include, for example, an identifier of the medicine; a strength of the medicine; an expiration date, lot number, and/or manufacturing date of the medicine; the identity of the patient to which the medicine has been prescribed; the identity of the medical professional who has prescribed the medicine; dosage and frequency information; interactions; indications and contraindications for the medicine; an amount of medicine in a container 190; a temperature of the medicine in the container 190; an ambient temperature at or near the container 190; or other information.

It will be appreciated that in some situations, the storage location 180 or components thereof may be made of a material (e.g., metal) that may impede or interfere with the signal from plurality of sensors 102a-d to the receiver 210. For example, the storage location 180 may be a refrigerator having a metal door. In some embodiments, therefore, the receiver 210 may incorporate and/or communicate with an antenna configured to be disposed so as to avoid such interference. FIG. 1B shows a tracking device 100 incorporating such a receiver antenna 212. In this example, the receiver antenna 212 is connected via a cable 214 to the receiver 210. The receiver antenna 212 and/or the cord 214 may extend from inside the storage location 180 to the receiver 210 in order to facilitate the reception, by the receiver 210, of signals from the tag 192. In some embodiments, the receiver antenna 212 may be configured and positioned in such a way as to employ a conductive surface of the storage location 180 (e.g., a metal door of a refrigerator) as an antenna, thereby increasing the strength of the signal to be received by the receiver 210.

In other embodiments where the storage location 180 or components thereof would interfere with signals from the sensors 102a-d, the receiver 210 may attempt to receive such signals only at certain times when the likelihood of doing so is higher. In one embodiment, the tracking device 100 may incorporate an accelerometer (not shown) to detect when a door of the storage location 180 (e.g., a refrigerator) is being opened, allowing signals to pass. In another embodiment, the tracking device 100 may incorporate or be connected to a photoresistor or other light sensor (not shown) disposed within the refrigerator. When light is detected, representing the ambient light and/or electric refrigerator light that strike the photoresistor when the door of the refrigerator is opened, the receiver 210 may attempt to immediately receive a signal from the tag 192. When no light is detected (signaling that the refrigerator door is closed), the receiver 210 may attempt to receive signals on a periodic basis. In still another embodiment, where the tracking device 100 is mounted to a door of the storage location 180, a tag (e.g., RFID) may be mounted in a fixed location relative to, and in proximity to, the tracking device 100, such as on a side surface of the storage location 180. When the tracking device 100 detects that the distance to the sensor has changed, it may be determined that the door has been opened, and the receiver may attempt to immediately receive a signal from the tag 192.

The tracking device 100 may also receive signals from the plurality of sensors 102a-d about the environment near the tracking device 100 or the container 190. The information may include, for example, an ambient room temperature at the tracking device 100; information about motion detected near the tracking device 100; or other information. The plurality of sensors 102a-d may include, for example, temperature sensors, a weight sensor, an optical sensor, an acoustic sensor, an inductance sensor, a capacitance sensor, a conductive contact sensor, a temperature sensor, an RFID tag reader, and a smart chip reader.

At least one of the plurality of sensors 102a, b may be disposed on or adjacent the tracking device 100. For example, an ambient temperature sensor may be incorporated into the housing of the tracking device 100. An acoustic sensor may also be incorporated into the tracking device 100.

At least one of a plurality of sensors 102c, d may be located some distance from the tracking device 100, such as inside the storage location 180. For example, a temperature sensor (e.g., a resistor) may be located inside a refrigerator in which the container 190 is stored. As another example, one or more containers 190 may be stored on a weight sensor (i.e., a scale, such as a capacitor or resistor) inside the storage location 180.

The information received from the sensors 102a-d may be used to increase or evaluate the patient's level of compliance with the treatment regimen. For example, a tag reading sensor may be used to detect the presence of a tag 192 on the container 190 and/or packaging 194 of the container 190. The tag 192 may be an RFID chip, a smart chip, or other tag configured to passively or actively transmit information to the tag reading sensor. For example, the detection of the tag 192 within a given proximity (e.g., 2 feet) of the tracking device 100 may indicate that the container 190 bearing the tag 192 has not yet been removed from the storage location 190. On the other hand, the detection of the tag 192 outside of a given proximity may indicate that the container 190 has been removed from the storage location 190, and may have been used in a treatment event, or soon will be.

As another example, the ambient temperature inside the storage location 190 and/or the temperature of the container 190 may be used to determine whether the medicine has been removed from the storage location 190, or to determine whether the temperature of the medicine is appropriate for the intended treatment. In some embodiments, the ambient temperature at the tracking device 100 may also be used, in conjunction with the current temperature of the medicine, to guide the patient in bringing the medicine to an appropriate temperature. For example, those temperatures may be used to estimate an amount of time that the currently- or recently-refrigerated medicine should be allowed to “sit out” at the ambient room temperature in the proximity of the tracking device 100 to achieve the appropriate temperature.

An optical characteristic or weight of the container 190 may be used to determine an amount of medicine remaining in the container 190. For example, a change in the weight of the container 190 may indicate that medicine has been removed from the container 190. As another example, the information from an optical sensor adjacent the container 190 may be used to determine that less medicine is visible, again indicating that medicine has been removed from the container 190. This information may be used to confirm that the patient has successfully completed a treatment event, or to refill a prescription for the medicine in the event.

The receiver 102a-d may receive the information from the sensors 102a-d directly or via a wired or wireless peer-to-peer or network connection such as Bluetooth, BLE, Wifi, 3G connection, wideband signal, optical signal, RFID, or the like.

With reference still to FIGS. 1A and 2, the network interface 220 may be configured to allow the tracking device 100 to communicate unidirectionally or bi-directionally with the server 120 and/or the medical device 130. For example, the network interface 220 may transmit information to the server 120, including the information obtained from the plurality of sensors 102a-d or determinations made about the patient's compliance. The network interface 220 may receive information from the server 120, including updates to the treatment regimen, patient data, communications to the patient, confirmations or notifications regarding prescription refills, software or firmware updates for the tracking device 100, or other information.

In some embodiments, the network interface 220 may allow a patient or other user of the tracking device 100 to communicate with others using interactive, near-real-time, or prerecorded audio/video communications. For example, the tracking device 100 may be configured to allow two-way streaming video communication, such as a video chat, between the patient and a family member, medical professional, or the like. Such video communication may be useful for facilitating conversation and for allowing the family member or medical professional to observe the patient for any issues revealed through the patient's appearance, movements, speech, or general demeanor or condition.

The network interface 220 may receive and/or transmit information from the medical device 130, including information about treatment events that the patient administered using the medical device 130. In some embodiments, the medical device 130 may be a needle-free injector of the type discussed in U.S. patent application Ser. No. 15/368,145, filed Dec. 2, 2016, titled “CONNECTED HEALTH PLATFORM INCLUDING NEEDLE-FREE INJECTOR SYSTEM,” the contents of which are hereby incorporated by reference for all purposes. In such embodiments, the medical device 130 may transmit to the tracking device 100 an indication of an error or other operating condition experienced by the medical device 130. In some embodiments, the network interface 220 may be configured to send requests to the medical device to take certain actions, such as downloading or installing new software or firmware; rebooting; entering a power save mode; or issuing a visual and/or audible cue as part of a call-response functionality to help the patient locate the medical device 130 when it has been misplaced.

The network interface 220 may communicate with the server 120 and/or the medical device 130 continuously, periodically, or upon request by the patient or other user.

The server 120 is configured to analyze the information received from the tracking device 100 and/or the medical device 130 and determine the patient's compliance with the regimen. Such compliance may be determined, for example, by comparing compliance information and/or information from the plurality of sensors 102a-d to a planned treatment regimen, including scheduled treatment events. The server 120 may use such a comparison to determine any discrepancies or deviation from the planned treatment regimen, and may communicate regarding the patient's compliance with the patient or with one or more third parties.

For example, the server 120 may be configured to communicate regarding the patient's compliance to one or more third parties over a network. For example, information about the patient's compliance with the treatment regimen may be sent to the patient's healthcare professional (e.g., physician 140 or hospital), payer (e.g., medical insurance company 160), a pharmacy 150, or others. Such information may be sent by mail or other message format, may be provided via an application programming interface (API) call, or may be provided in a database format or directly loaded into a database associated with or accessible by the third party.

A communication to the patient or other user about the compliance information may also be provided via a user interface 230 provided on the tracking device 100, with a plurality of user interface input elements 240, 250 provided to allow the user to provide input to the user interface 230. In some embodiments, the user interface 230 may be an LCD or LED display. The user interface input elements 240, 250 may be physical buttons adjacent the user interface 230, or may be “soft” buttons displayed on a region of the user interface 230. In some embodiments, a visual indicator 232 and/or an audio indicator 234 may be incorporated with the tracking device 100. For example, the visual indicator 232 could be one or more LED lights configured to flash when it is desired to get the patient's attention, such as in the event of a missed treatment event. The type and importance of the notification may be represented by different rates or patterns of flashing, or different color schemes. Similarly, the audio indicator 234 may provide audible cues, alerts, or commands to get the patient's attention, such as recorded verbal commands, audible alarms, intermittent chirps, or the like.

The user interface 230, the visual indicator 232, and/or the audio indicator 234 may communicate a variety of information to the patient or other user, and may be configured to receive input from the patient or other user. For example, the user interface 230 may remind the user of an impending treatment event, such as with a textual display (e.g., “UPCOMING TREATMENT”) or a countdown clock. As another example, the user interface 230 may remind the user of an overdue treatment event, such as with a textual display (e.g., “TREATMENT OVERDUE”) or a running clock indicating by how much the treatment is overdue. The patient or other user may be prompted to respond via the user interface input elements 240, 250. For example, the patient may be given the opportunity to “snooze” an impending or overdue treatment by disabling reminders and alerts for a certain amount of time. As another example, the patient may be given the opportunity to indicate that the treatment has been administered, and that further reminders and alerts are not warranted. As another example, the patient may be given the opportunity to skip the currently due treatment. Limits may be imposed on the ability to snooze or skip treatments. For example, a patient may not be given the opportunity to skip consecutive treatments. The patient may also be limited as to the number of times a treatment may be snoozed, or the duration of time the treatment may be snoozed. In some embodiments, successively shorter snooze durations may be available.

The user interface 230 may also provide the patient or other user with the opportunity to interact with one or more third parties. For example, the patient may be prompted to request a refill of medicine from a pharmacy when the amount of medicine the patient has remaining falls below a certain level. The patient may also be given the opportunity to contact, or request contact with, a pharmacy, designated caretaker, medical professional, or other. For example, the user interface 230 may allow the patient to request a call from a doctor, or may allow the patient to request emergency assistance by causing the network interface 220 to contact an emergency dispatcher (e.g., 9-1-1).

The user interface 230 may also provide the patient or other user with information about the medicine on hand or about future treatments. For example, the user interface 230 may indicate a number of doses of medicine left on hand. The user interface 230 may also provide information about an upcoming expiration of a container 190 of medicine. The user interface 230 may also be configurable to indicate other information relevant to the treatment regimen. For example, individuals suffering from rheumatoid arthritis may experience more pain as the relative humidity of the air increases. The user interface 230 may therefore be configurable to provide estimated relative humidity for a number of upcoming hours or days, or to provide an alert or notification when the estimated relative humidity is predicted to or actually does exceed a threshold relatively humidity.

In some embodiments, the user interface 230 may be configured to receive voice commands from the patient or other user, parse the voice commands to determine one or more requested actions to be taken by the tracking device 100, and cause those requested actions to be taken. For example, the user interface 230 may be configured to respond to a voice command “CALL 9-1-1!” by initiating a two-way audio connection with an emergency dispatcher. As another example, the user interface 230 may be configured to respond to a voice command “LIST INTERACTIONS” or “LIST INTERACTIONS WITH STATINS” by providing, via a speaker, a processed voice listing all interactions with the medicine in the treatment regimen, or all interactions between the medicine in the treatment regimen and statins, respectively. A locally-stored database may be accessed for information used in response to voice commands, or the network interface 220 may allow for querying or otherwise accessing a remote data store.

The processor 205 may run firmware or other software to control at least a portion of the operation of the tracking device 100, including the operation and interaction of the other components. The tracking device 100 may be powered by a direct or indirect (e.g., USB) connection to the power grid, may be battery powered, and/or utilize other power generation or conservation methods. In some embodiments, the tracking device 100 may have a primary source of power (e.g., AC power) and a backup source of power (e.g., a battery) in case of disruption to the primary source. In some embodiments, the tracking device 100 may be powered, or its battery recharged, by using a thermoelectric generator that exploits the temperature differential between the ambient temperature and the temperature inside a refrigerator (e.g., storage location 180). In other embodiments, photoelectric cells may be used.

In some embodiments, the processor 205 may be configured to optimize the operation of the tracking device 100 in order to minimize power usage and/or extend battery life. For example, the tracking device 100 may be configured to enter a standby or sleep mode during periods of inactivity, and/or when no scheduled treatment events are imminent.

The embodiments described above may be suitable for patients who do not have a computer or mobile device, or who do not wish to involve the computer or mobile device in the compliance process for some reason. Yet in some embodiments, the patient or other user may enroll one or more mobile devices in the compliance tracking system to further facilitate communication.

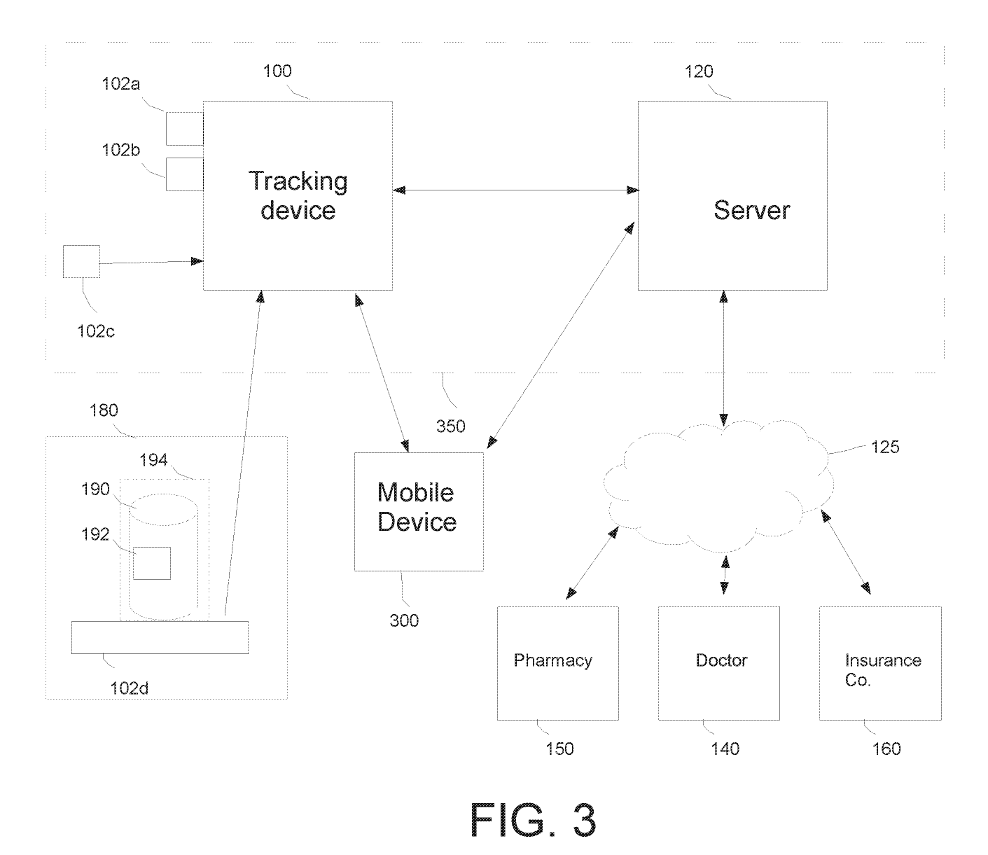

Thus, according to the embodiment seen in FIG. 3, a user's mobile device 300 may be part of, or participate in, the compliance tracking system 350. While many of the aspects and features of compliance tracking system 350 are identical or similar to those of compliance tracking system 150, some of the differences are discussed here. In some embodiments, the user interface 302 of the user's mobile device 300 may provide some or all of the interaction provided by the user interface 230 and the user interface input elements 240, 250 of the tracking device 100 discussed in the prior embodiments. In these embodiments, the tracking device 100 may continue to receive information from the plurality of sensors 102a-d, but may allow or cause the user's mobile device 300 to communicate with the patient.

While the embodiments described here refer to the user's “mobile device” for ease of reference, it will be appreciated that this may encompass mobile phones, music players (e.g., iPOD), tablets, desktop computers, laptop computers, web appliances, web-enabled televisions, and other computing devices.

In some embodiments, the user's mobile device 300 may incorporate additional sensors that gather information to be provided to the tracking device 100 and/or the server 120. For example, the user's mobile device 300 may detect an ambient temperature or an ambient sound level, and may determine the patient's movement, activity level, or location using accelerometer and or GPS, cellular, or Bluetooth information. This information may be used to further increase compliance. For example, if the movement data indicates that the patient is inactive (and possibly asleep) at the time of a scheduled treatment, customized actions may be taken to wake the patient, such as with a graduated audible and/or buzzing alarm. As another example, the location data may be used to remind the patient to administer a treatment when the patient is near the storage location 180. In conjunction with a motion sensor on the tracking device 100, such location data can be used to target such a reminder via the mobile device 300 and/or the tracking device 100, but avoid issuing such an alert any time motion is detected near the storage location, for example.

In any of the embodiments discussed herein, the server 120, the tracking device 100, the medical device 130, and/or the mobile device 300 may work to automatically identify compliance issues and identify actions or processes by which to improve compliance.

Consider an exemplary scenario in which the tracking device 100 detects that the patient has removed a container 190 of medicine from the storage location 180 (e.g., refrigerator). A temperature sensor of the plurality of sensors 102a-d may determine that, over a period of time, the temperature of the medicine in the container 190 has increased to approach room temperature. Finally, the medical device 130 communicates to the tracking device 100 that a treatment event has occurred some time later. It may be determined that this pattern of activity has recurred, and that the temperature of the medicine at the time of the treatment event is too high and may lead to a less-than-optimal outcome. In response, the server 120 and/or the tracking device 100 may generate a customized process for the patient. As part of such a process, the tracking device 100, upon detecting that the container 190 has been removed from the storage location, may immediately remind the patient via the user interface 230 to “ADMINISTER YOUR TREATMENT.” If the treatment is not administered within a certain amount of time, the patient may be given the suggestion to replace the container 190 in the storage location 180 and select another container that is at the proper temperature. In this manner, the less than optimal outcomes associated with the delay between removing the container 190 and the treatment event can be improved.

Consider another exemplary scenario in which the tracking device 100 and/or the server 120 determine that the patient has regularly missed a treatment event scheduled in the evening at or around bedtime. Movement data from the mobile device 300 confirms that the patient has been going to bed without administering a scheduled treatment. In response, the server 120 and/or the tracking device 100 may take steps to remind the patient to administer the scheduled treatment before going to bed. For example, if it is determined that the patient has been going to bed at 10 pm and missing a 10:30 scheduled treatment, the patient may be reminded at 9:50 that an upcoming treatment is scheduled; a modification to the treatment schedule may be proposed to allow the patient to administer the treatment at or before 10 pm; or some combination thereof. In some embodiments, additional sensors may be used to enhance the detection and remediation of such compliance issues. To continue the example, one of the plurality of sensors 102a-d may be a light sensor on the tracking device 100. If the tracking device 100 determines, via the light sensors, that the patient has turned out the lights at 9:45 pm, likely in preparation to go to bed before administering the scheduled treatment, a visual and/or audible alert may be issued by the tracking device 100 and/or the mobile device 300 reminding the patient to administer the treatment. In this manner, the suboptimal outcome associated with missed treatment events can be improved.

It will be appreciated that the functionalities of the compliance tracking systems discussed may be set and adapted according to the behaviors and preferences of the patient or other users. Nonetheless, a few exemplary use cases will now be described.

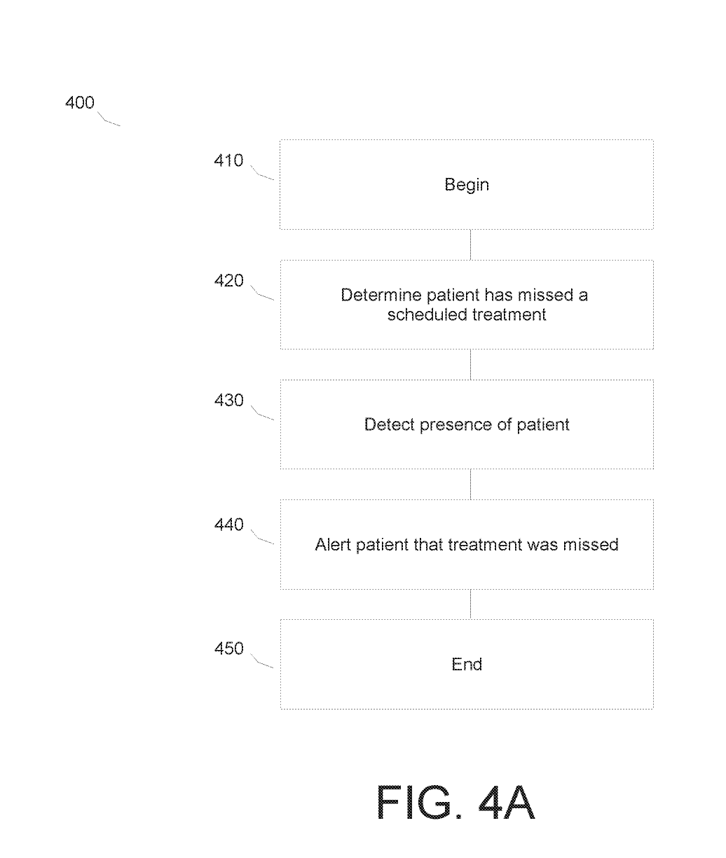

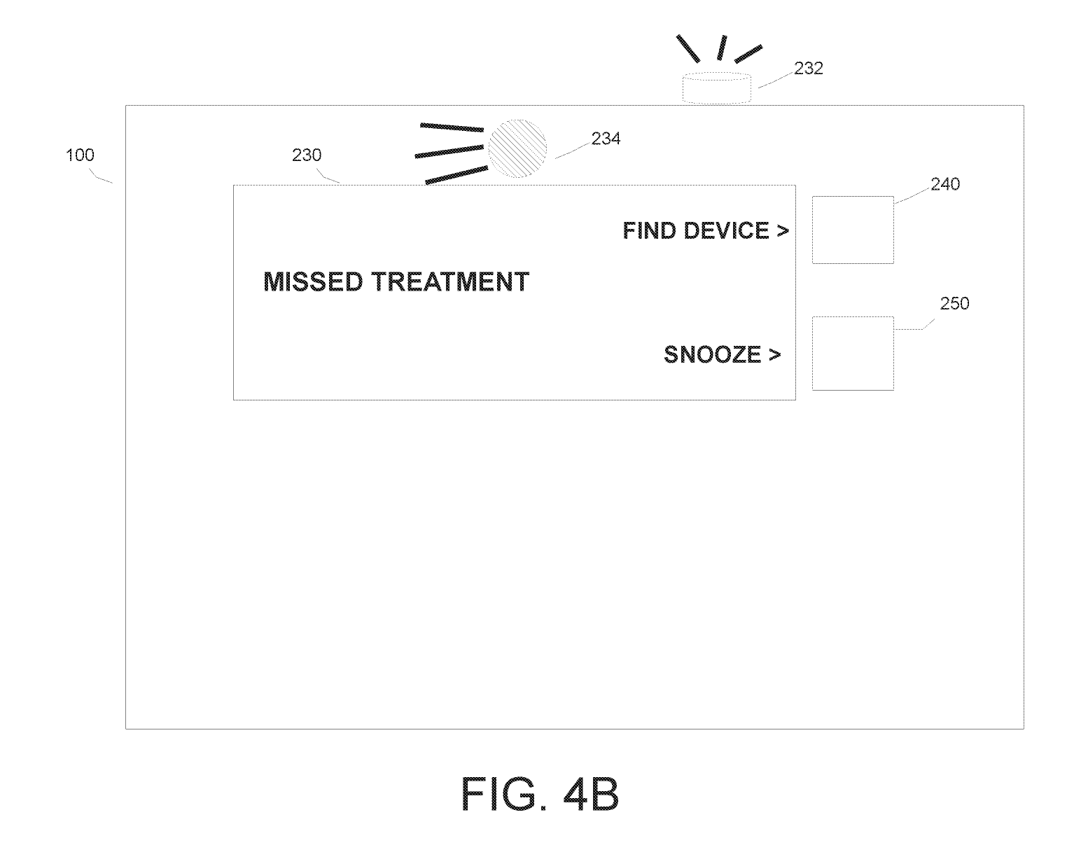

A first use case process 400 is described with reference to FIG. 4A.

Process 400 begins at step 410.

At step 420, it is determined by the compliance tracking system that a patient has missed a scheduled treatment. This determination may be made, for example, by comparing a history of treatment events to the patient's treatment regimen and determining that a recent scheduled treatment was not administered on schedule.

At step 430, the compliance tracking system attempts to detect the presence of the patient or other user in order to effectively issue an alert that the treatment event has been missed. In some embodiments, a motion sensor on a tracking device (e.g., tracking device 100) may detect motion near the refrigerator (e.g., storage location 180) in which the medicine is stored. In other embodiments, the patient's mobile device 300 may be determined to be in proximity of the refrigerator, and this information, either alone or in conjunction with the motion sensor information, may be used to determine that the patient is in proximity of the refrigerator.

At step 440, the tracking device may issue a visual and/or audible alert to the patient, indicating that a treatment has been missed. An exemplary view of the tracking device (e.g., tracking device 100) in such a state can be seen at FIG. 4B. For example, the tracking device 100 may emit a noise via audio indicator 234, may flash one or more lights via the visual indicator 232, and/or may provide a message via the user interface 230, e.g., “MISSED TREATMENT.” The user may be prompted to request, via the user interface input element 240, that the medical device (e.g., medical device 130) emit a noise, so that the user can easily locate the medical device in the event that the medical device has been misplaced. The user also may be given the opportunity to request, via the user interface input element 250, a delay of the scheduled treatment for some amount of time.

Returning to FIG. 4A, process 400 ends at step 450.

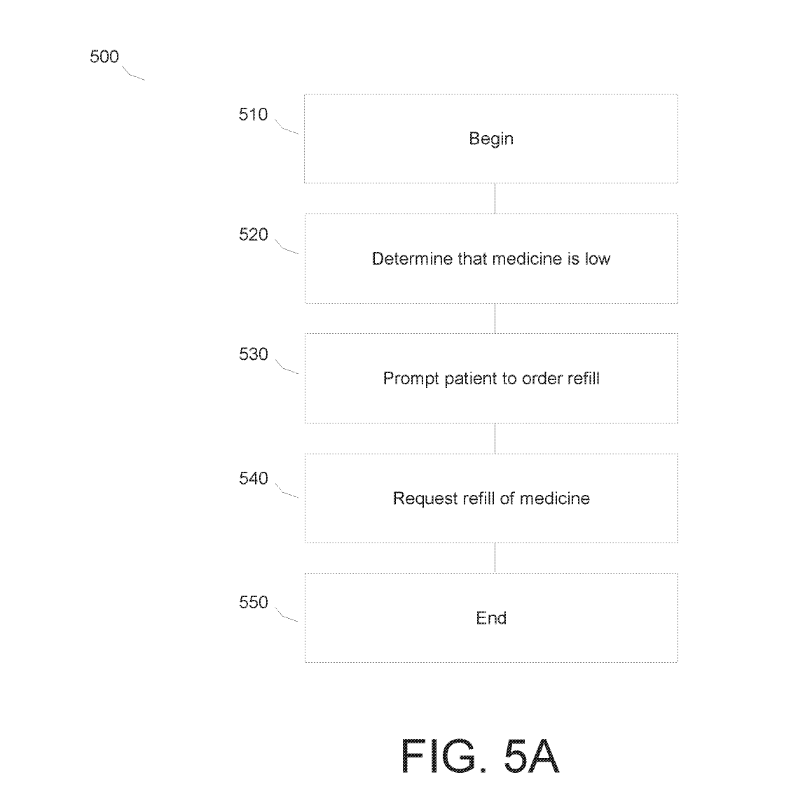

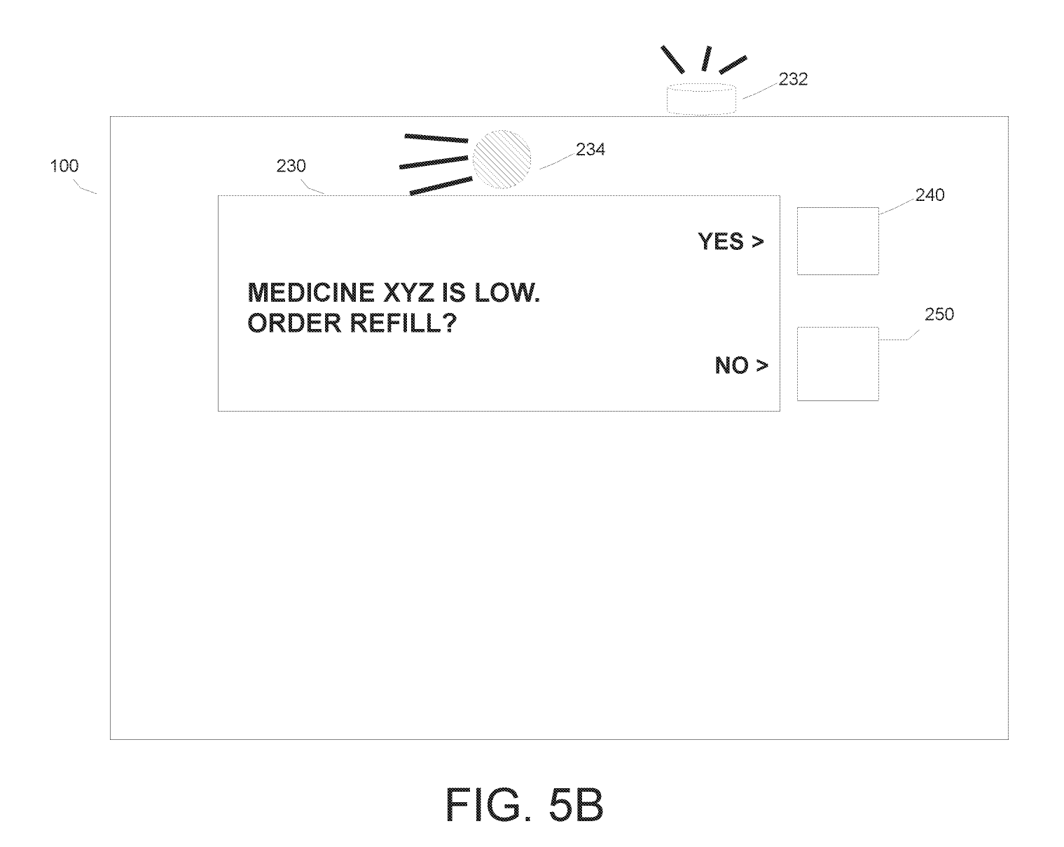

A second use case process 500 is described with reference to FIG. 5A.

Process 500 begins at step 510.

At step 520, it is determined by the compliance tracking system that the amount of medicine in the storage location 180 has dropped below a certain threshold. This determination may be made, for example, from the information provided by one or more of the plurality of sensors 102a-d as discussed above.

At step 530, the tracking device prompts the patient to order a refill of medicine via the user interface 230, e.g., “MEDICINE XYZ IS LOW. ORDER REFILL?” An exemplary view of the tracking device (e.g., tracking device 100) in such a state can be seen at FIG. 5B. The patient may be prompted to use the user interface input elements 240, 250 on the tracking device 100. For example, the patient may be prompted to enter “YES” or “NO’ by interacting with user interface elements 240 and 250, respectively.

At step 540, in response to the user choosing to order a refill of medicine, the tracking device 100 may forward the request to a server (e.g., server 120), which may pass the request along to a medical professional (e.g., the patient's doctor) and/or a pharmacy. In some embodiments, the medical professional may be required to approve some requests before they are fulfilled by the pharmacy, e.g., where the medicine is a controlled substance for which dispensation is strictly regulated. The server may coordinate the process with the medical professional and the pharmacy through such approval and fulfillment steps.

Returning to FIG. 5A, process 500 ends at step 550.

As discussed above, aspects and functions disclosed herein may be implemented as hardware or software on one or more of these computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers. Additionally, aspects may be performed on a client-server or multi-tier system that includes components distributed among one or more server systems that perform various functions. Consequently, examples are not limited to executing on any particular system or group of systems. Further, aspects may be implemented in software, hardware or firmware, or any combination thereof. Thus, aspects may be implemented within methods, acts, systems, system elements and components using a variety of hardware and software configurations, and examples are not limited to any particular distributed architecture, network, or communication protocol.

The computer devices described herein are interconnected by, and may exchange data through, a communication network. The network may include any communication network through which computer systems may exchange data. To exchange data using the network, the computer systems and the network may use various methods, protocols and standards, including, among others, Fibre Channel, Token Ring, Ethernet, Wireless Ethernet, Bluetooth, Bluetooth Low Energy (BLE), IEEE 802.11, IP, IPV6, TCP/IP, UDP, DTN, HTTP, FTP, SNMP, SMS, MMS, SS7, JSON, SOAP, CORBA, REST and Web Services. To ensure data transfer is secure, the computer systems may transmit data via the network using a variety of security measures including, for example, TSL, SSL or VPN.

The computer systems include processors that may perform a series of instructions that result in manipulated data. The processor may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller.

A memory may be used for storing programs and data during operation of the device. Thus, the memory may be a relatively high performance, volatile, random access memory such as a dynamic random access memory (DRAM) or static memory (SRAM). However, the memory may include any device for storing data, such as a disk drive or other non-volatile storage device. Various examples may organize the memory into particularized and, in some cases, unique structures to perform the functions disclosed herein.

The devices (e.g., the tracking device 100, the medical device 130, and the mobile device 300) may also include one or more interface devices such as input devices and output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system to exchange information and communicate with external entities, such as users and other systems.

Data storage may include a computer readable and writeable nonvolatile (non-transitory) data storage medium in which instructions are stored that define a program that may be executed by the processor. The data storage also may include information that is recorded, on or in, the medium, and this information may be processed by the processor during execution of the program. More specifically, the information may be stored in one or more data structures specifically configured to conserve storage space or increase data exchange performance. The instructions may be persistently stored as encoded signals, and the instructions may cause the processor to perform any of the functions described herein. The medium may, for example, be optical disk, magnetic disk or flash memory, among others. In operation, the processor or some other controller may cause data to be read from the nonvolatile recording medium into another memory, such as the memory, that allows for faster access to the information by the processor than does the storage medium included in the data storage. The memory may be located in the data storage or in the memory, however, the processor may manipulate the data within the memory, and then copy the data to the storage medium associated with the data storage after processing is completed. A variety of components may manage data movement between the storage medium and other memory elements and examples are not limited to particular data management components. Further, examples are not limited to a particular memory system or data storage system.

Various aspects and functions may be practiced on one or more computers having a different architectures or components than that shown in the Figures. For instance, one or more components may include specially programmed, special-purpose hardware, such as for example, an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

One or more components may include an operating system that manages at least a portion of the hardware elements described herein. A processor or controller may execute an operating system which may be, for example, a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, an Android operating system available from Google, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular implementation.

The processor and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C♯ (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform described functions.

What is claimed is:

1. A compliance tracking device comprising:
a receiver configured to receive a signal from at least one sensor, the signal containing information regarding at least one container of medicine;
a processor configured to determine, from the information, a communication regarding the at least one container of medicine;
a network interface configured to transmit the communication; and
a user interface configured to provide an indication regarding the at least one container of medicine.

2. The compliance tracking device of claim 1, wherein the information includes at least one of a proximity of the at least one container to the receiver, a quantity of the medicine, an expiration status of the medicine, a temperature of the medicine, an ambient temperature at the container, and an indication that the container has moved.

3. The compliance tracking device of claim 2, wherein the information includes an indication that the at least one container has been removed from a first location.

4. The compliance tracking device of claim 3, wherein the sensor is at least one of a weight sensor, an optical sensor, an acoustic sensor, an inductance sensor, a capacitance sensor, a conductive contact sensor, a temperature sensor, an RFID tag, and a smart chip.

5. The compliance tracking device of claim 1, further comprising a motion sensing component configured to detect a movement in a proximity of the compliance tracking device.

6. The compliance tracking device of claim 1, further comprising at least one of an audio or visual alarm component configured to be activated in response to a determination regarding the at least one container of medicine.

7. The compliance tracking device of claim 1, wherein the network interface is configured to transmit the communication to a server.

8. The compliance tracking device of claim 7, wherein the network interface is configured to transmit information regarding at least one treatment event to at least one of a medical professional, a public safety dispatcher, a caretaker, an emergency contact, and a family member.

9. The compliance tracking device of claim 1, wherein the network interface is configured to communicate with a medical treatment device configured to administer the medicine in a treatment of the patient.

10. The compliance tracking device of claim 9, wherein the network interface is configured to receive, from the medical treatment device, information regarding at least one treatment event.

11. The compliance tracking device of claim 9, wherein the network interface is configured to communicate with the medical treatment device over at least one of a IEEE 802.11 network, a Bluetooth connection, and a Bluetooth Low Energy connection.

12. The compliance tracking device of claim 9, wherein the user interface is further configured to provide an indication regarding at least one of an upcoming treatment event, a quantity of the medicine, an expiration status of the medicine, and a temperature of the medicine.

13. The compliance tracking device of claim 12, wherein the indication is at least one of a visual notification and an audible notification.

14. The compliance tracking device of claim 9, wherein the user interface is further configured to provide an indication regarding a status of the medical treatment device.

15. The compliance tracking device of claim 14, wherein the status relates to at least one of a power source of the medical treatment device and an operational status of the medical treatment device.

16. The compliance tracking device of claim 9, wherein the user interface is further configured to receive, from a user, an instruction to the medical treatment device to issue an alert, and wherein the network interface is further configured to transmit the instruction to the medical treatment device.

17. The compliance tracking device of claim 1, wherein the receiver further comprises a receiver antenna, with at least a portion of the receiver antenna configured to be positioned to receive the signal from the at least one sensor.

18. The compliance tracking device of claim 1, further comprising a component configured to detect a favorable condition for receiving the signal from the at least one sensor.

19. The compliance tracking device of claim 18, wherein the component is at least one of an accelerometer and a light sensor.

20. The compliance tracking device of claim 1, wherein the receiver is further configured to detect a distance between the receiver and a fixed sensor and identify, based on the distance, a favorable condition for receiving the signal from the at least one sensor.

21. The compliance tracking device of claim 1, wherein the user interface is further configured to:
display a first indication regarding an upcoming treatment event;
detect a user interaction with an element of the user interface; and
cease displaying the first indication responsive to detecting the user interaction.

22. The compliance tracking device of claim 21, wherein the user interaction with the element of the user interface is a user pushing a user interface button indicating at least one of the user's compliance with the upcoming treatment event and the user's request to cancel the first indication.

23. The compliance tracking device of claim 21, wherein the user interface is further configured to display, following a predetermined time period after the user interaction, a second indication regarding the upcoming treatment event.

24. The compliance tracking device of claim 23, wherein the user interaction with the element of the user interface is a user pushing a snooze button.

25. The compliance tracking device of claim 1, wherein the network interface is further configured to transmit an order for a refill of medicine.

26. The compliance tracking device of claim 1, wherein the network interface is further configured to request an interactive communication with at least one of a medical professional, a public safety dispatcher, a caretaker, an emergency contact, and a family member.

27. The compliance tracking device of claim 1, wherein the user interface is further configured to allow a user to transmit at least one of an image, an audio communication, and a video communication to at least one of a medical professional, a public safety dispatcher, a caretaker, an emergency contact, and a family member.

28. The compliance tracking device of claim 1, wherein the user interface is further configured to:
receive, via an audio sensor, at least one voice command from a user;
determine a responsive communication to be provided to the user in response to the at least one voice command; and
communicate the responsive communication via the user interface.

29. The compliance tracking device of claim 1, wherein the processor is further configured to determine an effectiveness of an intervention.
